(19) United States
(12) Patent Application Publication
(10) Pub. No.: US 2025/0379949 A1
(43) Pub. Date: Dec. 11, 2025

(54) IMAGE PROCESSING APPARATUS

(71) Applicant: KYOCERA Document Solutions Inc., Osaka (JP)

(72) Inventors: Kosuke TAKI, Osaka (JP); Zhouning DU, Osaka (JP)

(73) Assignee: KYOCERA Document Solutions Inc., Osaka (JP)

(21) Appl. No.: 19/231,103

(22) Filed: Jun. 6, 2025

(30) Foreign Application Priority Data
Jun. 10, 2024 (JP) 2024-093619

(51) Int. Cl. H04N 1/00; G06V 10/26; G06V 10/74; G06V 10/764; G06V 30/148; G06V 30/19; G06V 30/244

(52) U.S. Cl. CPC H04N 1/00816; G06V 10/267; G06V 10/761; G06V 10/764; G06V 30/15; G06V 30/19093; G06V 30/2455; H04N 1/00331; H04N 2201/0094

(57) ABSTRACT

A control portion performs a first region detection process to detect a first region expected to individually include either a region of an item name or a region of an item value, a second region detection process to detect a second region expected to include both a region of an item name and a region of an item value corresponding to the same item, and a process of linking together a plurality of first regions included in the same second region. The control portion further performs a process of detecting a hand-written region in which characters are printed characters.

### INCORPORATION BY REFERENCE

This application is based on and claims the benefit of priority from Japanese Patent Application No. 2024-093619 filed on Jun. 10, 2024, the contents of which are hereby incorporated by reference.

### BACKGROUND

The present disclosure relates to image processing apparatuses.

Some known image processing apparatuses read a personal identification card as a document and mask, out of the image data obtained by the reading, a region corresponding to personal information.

For example, the personal information on the personal identification card is classified into a plurality of items. Those items include name, address, and the like. With such personal identification cards, there may be cases where, out of the image data obtained by reading them, only a region corresponding to a specified item needs to be masked. The region that needs to be masked varies from one user to another.

### SUMMARY

According to one aspect of the present disclosure, an image processing apparatuses includes an image reading portion and a control portion. The image reading portion that reads a document that contains a plurality of sets of item names and item values with respect to items related to personal information. The control portion recognizes a target item which is, among the items, an item to be masked and, by performing a masking process on the image data obtained through reading of the document by the image reading portion, generates masked data in which at least part of the region of the target item present in the image data is masked. The control portion performs a first region detection process to detect, from the image data, a first region expected to individually include either a region of an item name or a region of an item value, a second region detection process to detect a second region expected to include both a region of an item name and a region of an item value corresponding to the same item, an including region detection process, as a process performed for each of a plurality of the first regions, to detect a second region having an image portion with a degree of image similarity equal to or greater than a threshold value with respect to the first region of the process target, thereby to detect the second region that includes the first region, and a region linking process to link together a plurality of first regions included in the same second region. In the first and second region detection processes, a printed character region in which characters are printed characters is detected. The control portion further performs a hand-written region detection process to detect a hand-written region in which characters are hand-written characters.

### BRIEF DESCRIPTION OF THE DRAWINGS

FIG. 1 is a schematic diagram of a multifunction peripheral according to an embodiment.

FIG. 2 is a block diagram of the multifunction peripheral according to the embodiment.

FIG. 3 is a diagram schematically showing one example of a personal identification card that can be a target of reading on the multifunction peripheral according to the embodiment.

FIG. 4 is a flow chart showing the procedure of a masking job performed on the multifunction peripheral according to the embodiment.

FIG. 5 is a diagram showing first regions in the image data obtained by reading the personal identification card shown in FIG. 3.

FIG. 6 is a diagram showing second regions in the image data obtained by reading the personal identification card shown in FIG. 3.

FIG. 7 is a diagram showing masked data generated in a masking job performed with the personal identification card shown in FIG. 3 as the target.

FIG. 8 is a conceptual diagram of dictionary data used in the masking job on the multifunction peripheral according to the embodiment.

FIG. 9 is a flow chart showing the procedure of a region discrimination process performed on the multifunction peripheral according to the embodiment.

FIG. 10 is a flow chart showing the procedure of a first error handling process performed on the multifunction peripheral according to the embodiment.

FIG. 11 is a flow chart showing the procedure of a first and a second error handling process performed on the multifunction peripheral according to the embodiment.

FIG. 12 is a flow chart showing the procedure of the second error handling process performed on the multifunction peripheral according to the embodiment.

FIG. 13 is a flow chart showing the procedure of the third error handling process performed on the multifunction peripheral according to the embodiment.

FIG. 14 is a flow chart showing the procedure performed when the setting of a masking job is accepted on the multifunction peripheral according to the embodiment.

FIG. 15 is a diagram showing an input screen displayed on the multifunction peripheral according to the embodiment.

FIG. 16 is a diagram showing a registration screen displayed on the multifunction peripheral according to the embodiment.

FIG. 17 is a diagram schematically showing one example of a personal identification card (one containing a hand-written signature) that can be a target of reading on the multifunction peripheral according to the embodiment.

FIG. 18 is a flow chart showing procedure of a masking job (one in which a hand-written region detection process is additionally performed) performed on the multifunction peripheral according to the embodiment.

FIG. 19 is a diagram showing first regions and a hand-written region in the image data obtained by reading the personal identification card shown in FIG. 17.

FIG. 20 is a diagram showing second regions and a hand-written region in the image data obtained by reading the personal identification card shown in FIG. 17.

FIG. 21 is a diagram showing masked data generated in a masking job performed with the personal identification card shown in FIG. 17 as the target.

### DETAILED DESCRIPTION

### Construction of a Multifunction Peripheral

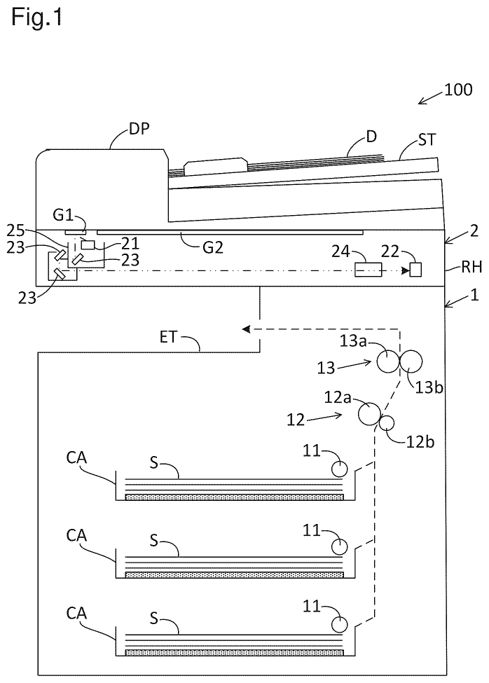

With reference to FIGS. 1 to 21, an image processing apparatuses according to one embodiment of the present disclosure will be described, taking as an example a multifunction peripheral 100 having a plurality of kinds of function such as scanning, printing, and data transmission.

As shown in FIG. 1, the multifunction peripheral 100 (corresponding to an “image processing apparatus”) includes a printing portion 1. The printing portion 1 constitutes the main unit of the multifunction peripheral 100. The printing portion 1 prints an image on a sheet S. The printing portion 1 employs an electrophotographic printing method. This, however, is not meant as any limitation. The printing portion 1 can employ an inkjet printing method.

The printing portion 1 forms an image based on image data fed in to the multifunction peripheral 100. The printing portion 1 also conveys the sheet S along a sheet conveyance passage. The printing portion 1 prints the image on the sheet S being conveyed. In FIG. 1, the sheet conveyance passage is indicated by a broken line.

The printing portion 1 includes a sheet feed roller 11. The sheet feed roller 11 lies in contact with the sheet S stored in a sheet cassette CA and rotates in that state. Thus the sheet feed roller 11 feeds the sheet S from the sheet cassette CA to the sheet conveyance passage.

The printing portion 1 includes an image forming portion 12. The image forming portion 12 includes a photosensitive drum 12a and a transfer roller 12b. The photosensitive drum 12a carries a toner image on its circumferential surface. The transfer roller 12b lies in pressed contact with the photosensitive drum 12a to form a transfer nip with the photosensitive drum 12a. The transfer roller 12b rotates together with the photosensitive drum 12a. The image forming portion 12, while conveying the sheet S having entered to the transfer nip, transfers the toner image to the sheet S.

The image forming portion 12 further includes, though not shown, a charging device, an exposure device, and a development device. The charging device electrostatically charges the circumferential surface of the photosensitive drum 12a. The exposure device forms an electrostatic latent image on the circumferential surface of the photosensitive drum 12a. The development device develops the electrostatic latent image on the circumferential surface of the photosensitive drum 12a into a toner image.

The printing portion I includes a fixing portion 13. The fixing portion 13 includes a heating roller 13a and a pressing roller 13b. The heating roller 13a incorporates a heater (not shown). The pressing roller 13b lies in pressed contact with the heating roller 13a to form a fixing nip with the heating roller 13a. The pressing roller 13b rotates together with the heating roller 13a. The fixing portion 13, while conveying the sheet S having entered the fixing nip, fixes the toner image transferred to the sheet S to the sheet S. The sheet S having left the fixing nip is discharged to a discharge tray ET.

The multifunction peripheral 100 also includes an image reading portion 2. The image reading portion 2 is disposed in an upper part of the main unit of the multifunction peripheral 100. In a job involving the reading of a document D, the document D is set on the image reading portion 2. The image reading portion 2 reads the document D set on it to generate the image data of the read document D.

The image reading portion 2 includes contact glasses G1 and G2. The contact glasses G1 and G2 are provided in the housing RH of the image reading portion 2. The housing RH has an opening in its top face. The contact glasses G1 and G2 are fitted in the opening in the top face of the housing RH.

The image reading portion 2 includes a document conveying device DP. The document conveying device DP is fitted to the housing RH. The document conveying device DP pivots such that, as seen from in front of the multifunction peripheral 100, a front part of the document conveying device DP swings up and down about a rear part of it as a pivot point. The document conveying device DP opens and closes relative to the top face of the housing RH.

The document conveying device DP has a set tray ST on which the document D is set. The document conveying device DP conveys the document D set on the set tray ST onto the contact glass G1.

In a feed-reading mode, the user sets the document D on the set tray ST. The document D automatically conveyed onto the contact glass G1 by the document conveying device DP (in other words, the document D passing over the contact glass G1) is read. On the other hand, in a stationary reading mode, the user sets the document D on the contact glass G2 and the document D on the contact glass G2 is read.

The image reading portion 2 includes a light source 21, an image sensor 22, a mirror 23, and a lens 24. The light source 21, the image sensor 22, the mirror 23, and the lens 24 are provided in the housing RH. The image reading portion 2 carries out scanning operation in which it shines light from the light source 21 to the contact glass G1 or G2 and performs photoelectric conversion with the image sensor 22.

The light source 21 has a plurality of LED elements. The plurality of LED elements are arrayed in a row along a main scanning direction (the direction perpendicular to the plane of FIG. 1). The image sensor 22 has a plurality of photoelectric conversion elements lined up along the main scanning direction. The mirror 23 reflects light toward the lens 24. The lens 24 collects the light reflected from the mirror 23 to direct it to the image sensor 22.

The light source 21 and the mirror 23 are provided on a carriage 25 that is movable along a sub (subsidiary) scanning direction (in FIG. 1, the left-right direction) orthogonal to the main scanning direction. As the carriage 25 moves along the sub scanning direction, the reading line of the image reading portion 2 moves along the sub scanning direction.

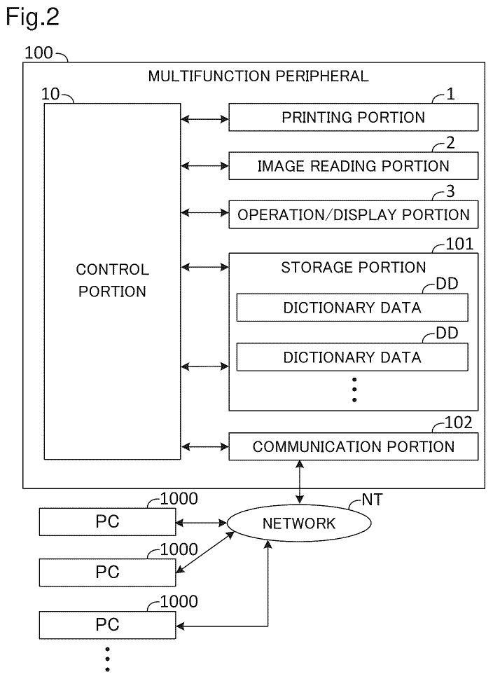

As shown in FIG. 2, the multifunction peripheral 100 includes an operation/display portion 3. The operation/display portion 3 is an operation panel having a touch screen. The operation/display portion 3 displays software buttons, messages, and the like on the touch screen. The operation/display portion 3 also has a plurality of hardware buttons. The operation/display portion 3 accepts operations from the user. Through the operation/display portion 3 the user can do the setting of various jobs including a masking job, which will be described later.

The multifunction peripheral 100 includes a control portion 10. The control portion 10 includes a CPU, an ASIC, a memory, and the like. The control portion 10 includes an image processing circuit. The control portion 10 performs various kinds of image processing on image data. The control portion 10 also controls the printing on the sheet S by the printing portion 1 and the reading of the document D by the image reading portion 2.

The control portion 10 also controls the operation/display portion 3. Specifically, the control portion 10 controls display operation on the touch screen. The control portion 10 senses operations on the software buttons and the hardware buttons. Based on the operations that the operation/display portion 3 accepts from the user, the control portion 10 performs the setting of a job.

The multifunction peripheral 100 includes a storage portion 101. The storage portion 101 is a non-volatile storage device. As the storage portion 101, a HDD, an SSD, and the like can be used. The storage portion 101 is connected to the control portion 10. The control portion 10 writes information to, and reads information from, the storage portion 101.

The storage portion 101 previously stores predetermined information. For example, the storage portion 101 previously stores a character recognition program. Based on the character recognition program the control portion 10 performs a character recognition process such as an OCR (optical character recognition) process. The control portion 10 takes the image data obtained through the reading of the document D by the image reading portion 2 as the target of the character recognition process.

The multifunction peripheral 100 includes a communication portion 102. The communication portion 102 is an interface that permits an external device to be connected to the multifunction peripheral 100 so that communication is possible between them. The communication portion 102 includes a communication circuit, a communication memory, a communication connector, and the like. The communication portion 102 is connected to the control portion 10. Using the communication portion 102 the control portion 10 exchanges data with the external device.

The communication portion 102 is connected to the external device across a network NT such as a LAN and the internet so that communication is possible between them. Thought not shown, the communication portion 102 can be connected directly to the external device across a communication cable. The external device connected to the communication portion 102 can be, for example, a personal computer 1000 (in the following description referred to as the PC 1000) that is used by the user of the multifunction peripheral 100. Any external device other than the PC 1000 can be connected to the multifunction peripheral 100 so that communication is possible between them. Connecting the PC 1000 to the multifunction peripheral 100 permits the image data of the document D obtained through the reading of the document D by the image reading portion 2 to be transmitted to the image reading portion 2. The image data of the document D can then be stored on the PC 1000.

### Outline of a Masking Job

When making a contract for a product or a service, the prospective purchaser is often required to register his or her personal information. This is merely one example and many other various occasions require the registration of personal information. Example of personal information include name, address, and date of birth.

The user of the multifunction peripheral 100 assumes the task of registering personal information. When registering personal information, the user reads a personal identification card using the scanning function of the multifunction peripheral 100. Many kinds of personal identification card can be the target and they vary from one state, field, or the like to another. Examples of personal identification cards include driving licenses, health insurance cards, student identification cards, and passports.

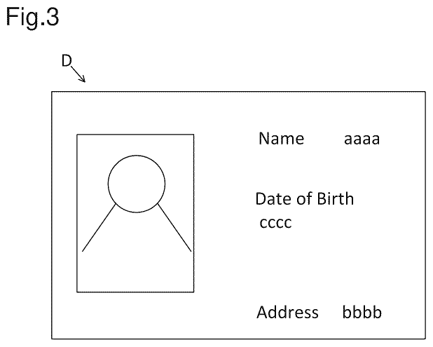

One example of a personal identification card is schematically shown in FIG. 3. The personal identification card bears personal information in a form classified into a plurality of items. Specifically, the personal identification card bears a plurality of sets of item names and item values with respect to items related to personal information. In the example shown in FIG. 3, the character string “Name” corresponds to an item name and the character string “aaaa” corresponds to the item value of the item corresponding to the item name “Name.” Likewise, the character string “Address” corresponds to an item name and the character string “bbbb” corresponds to the item value of the item corresponding to the item name “Address.” Likewise, the character string “Date of Birth” corresponds to an item name and the character string “cccc” corresponds to the item value of the item corresponding to the item name “Date of Birth.”

When the personal identification card shown in FIG. 3 is read, the image data obtained through the reading of the personal identification card contains a character region including the character string “Name” indicating an item name and a character region including the character string “aaaa” indicating an item value. It also contains a character region including the character string “Address” indicating an item name and a character region including the character string “bbbb” indicating an item value. It further contains a character region including the character string “Date of Birth” indicating an item name and a character region including the character string “cccc” indicating an item value.

In the following description, wherever distinction is needed among the different character regions, the character region of the item name “Name” is identified by the reference sign C11 and the character region of the item value “aaaa” is identified by the reference sign C12; the character region of the item name “Address” is identified by the reference sign C21 and the character region of the item value “bbbb” is identified by the reference sign C22; and the character region of the item name “Date of Birth” is identified by the reference sign C31 and the character region of the item value “cccc” is identified by the reference sign C32.

After the personal identification card is read on the multifunction peripheral 100, an image based on the image data of the personal identification card obtained by the reading (i.e., the personal information on the personal identification card) is printed on the sheet S. The sheet S having the personal information printed on it is then stored. In this way, the personal identification card is registered. Instead, the image data itself (i.e., electronic data) of the personal identification card can be stored.

Here, as the case may be, part of personal information has to be masked. For example, while a personal identification card has a box for date of birth, a contract for a product or a service may not require it. In this example, personal information related to date of birth may have to be masked. For another example, depending on the country, while a personal identification card has a box for religion, personal information related to religion is prohibited from being recorded. In this example, personal information related to religion may have to be masked.

For example, it is widely practiced to manually black out personal information to be masked to conceal it. The user however finds it troublesome to manually mask part of personal identification card.

To cope with that, the multifunction peripheral 100 is provided with a masking function. In other words, the multifunction peripheral 100 can execute a job involving the masking function (in the following description referred to simply as the masking job).

By using the masking function one can obtain masked data, that is, image data in which part of the personal information on a personal identification card is masked. An image based on the masked data can then be printed on a sheet S, or the masked data can be transmitted to the PC 1000 to be stored on it.

When a masking job is executed, its setting is done. In the setting of a masking job, what personal information to mask can be freely set. The setting of a masking job will be described in detail later.

After the setting of a masking job, the user sets a personal identification card as a document D on the image reading portion 2. In that state the user makes a starting operation for the masking job on the operation/display portion 3. On sensing the starting operation made on the operation/display portion 3, the control portion 10 starts the masking job.

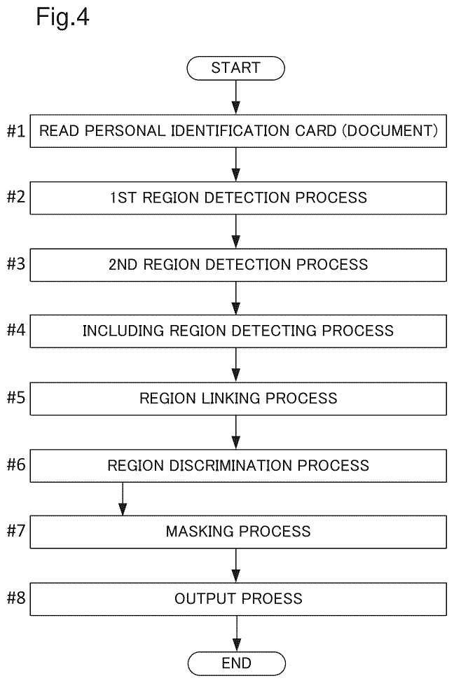

Now, with reference to the flow chart shown in FIG. 4, the procedure of a masking job will be described. The flow in FIG. 4 starts when the control portion 10 senses a starting operation for a masking job on the operation/display portion 3.

Before making the starting operation for a masking job, the user does the setting of the masking job. In the setting of the masking job, the user specifies a target item which is an item corresponding to an item value to be masked. When executing the masking job, the control portion 10 recognizes the target item specified by the user.

At Step #1, the control portion 10 makes the image reading portion 2 read the personal identification card as the document D. The image reading portion 2 reads the personal identification card to generate the image data of the read personal identification card (i.e., the scanning data of the personal identification card). The control portion 10 acquires the image data of the personal identification card obtained through the reading of the personal identification card by the image reading portion 2.

At Step #2, using a first learning model obtained through machine learning, the control portion 10 performs a first region detecting process. As the first region detecting process, the control portion 10 performs a process of detecting from the image data of the personal identification card a first region that is expected to individually include a region of an item name or a region of an item value.

The first learning model for the first region detecting process is a learning model that is trained to detect a first region from the image data obtained through the reading of a personal identification card by the image reading portion 2. The first learning model is a trained model and is previously stored in the storage portion 101.

A personal identification card typically shows a plurality of pairs of item names and item values; thus, in the first region detecting process, a plurality of first regions are detected. So, if the first region detecting process ends in detecting no first region, or if the first region detecting process ends in detecting only one first region, the masking job can be terminated and a message prompting the user to check the document D on the image reading portion 2 can be displayed on the operation/display portion 3.

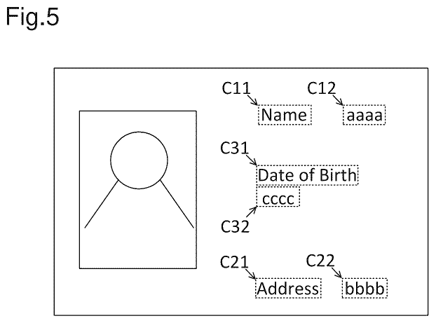

In the personal identification card shown in FIG. 3, the character region C11 of the item name “Name,” the character region C12 of the item value “aaaa,” the character region C21 of the item name “Address,” the character region C22 of the item value “bbbb,” the character region C31 of the item name “Date of Birth,” and the character region C32 of the item value “cccc” are detected individually, each as a first region. The first regions are shown with emphasis in FIG. 5.

At Step #3, using a second learning model obtained through machine learning, the control portion 10 performs a second region detecting process. As the second region detecting process, the control portion 10 performs a process of detecting, from the image data of the personal identification card, a second region that is expected to include regions of both an item name and an item value corresponding to the same item.

The second learning model for the second region detecting process is a learning model trained to detect a second region from the image data obtained through the reading of a personal identification card by the image reading portion 2. The second learning model is a trained model and is previously stored in the storage portion 101.

In a case where a personal identification card has been read, the second region detecting process ends in detecting at least one second region. If the second region detecting process ends in detecting no second region, something different from a personal identification card may have been read. Accordingly, if the second region detecting process ends in detecting no second region, the masking job can be terminated and a message prompting the user to check the document D on the image reading portion 2 can be displayed on the operation/display portion 3.

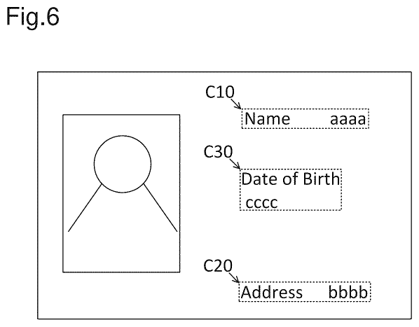

In the example shown in FIG. 5, the regions C10, C20, and C30 shown in FIG. 6 are each detected as a second region. Specifically, one region C10 including the character region C11 of the item name “Name” and the character region C12 of the item value “aaaa” is detected as a second region; one region C20 including the character region C21 of the item name “Address” and the character region C22 of the item value “bbbb” is detected as a second region; and one region C30 including the character region C31 of the item name “Date of Birth” and the character region C32 of the item value “cccc” is detected as a second region.

At Step #4, for each of the plurality of first regions detected in the first region detecting process, the control portion 10 performs an including region detecting process. The plurality of first regions are each taken once as the target of the including region detecting process. The control portion 10 performs the including region detecting process for one first region as the process target and, on completing the including region detecting process for it, performs the including region detecting process for another first region not yet taken as the process target as the new process target.

As the including region detecting process, the control portion 10 performs a process of detecting a second region that includes the first region of the process target. To detect a second region that includes the first region of the process target, the control portion 10 detects a second region that has an image portion of which the degree of image similarity to the first region of the process target is equal to or more than a threshold value for the including region detecting process. The control portion 10 judges that a second region that has an image portion of which the degree of image similarity to the first region of the process target is equal to or more than the threshold value for the including region detecting process includes the first region. At this point, no character recognition process has yet been performed. That is, the degree of image similarity is the degree of similarly between two sets of image data, and is not the degree of similarity between character strings (between two sets of text data). The control portion 10 performs the including region detecting process, for example, by employing a known pattern matching technology. The threshold value for the including region detecting process is 70% or more, with no limitation intended.

In the example shown in FIGS. 5 and 6, the second region C10 has an image portion of which the degree of image similarity to the first region C11 (the region of the item name “Name”) and has an image portion of which the degree of image similarity to the first region C12 (the region of the item value “aaaa”). The second region C20 has an image portion of which the degree of image similarity to the first region C21 (the region of the item name “Address”) and has an image portion of which the degree of image similarity to the first region C22 (the region of the item value “bbbb”). The second region C30 has an image portion of which the degree of image similarity to the first region C31 (the region of the item name “Date of Birth”) and has an image portion of which the degree of image similarity to the first region C32 (the region of the item value “cccc”). Thus, the first regions C11 and C12 are judged to be included in the second region C10, the first regions C21 and C22 are judged to be included in the second region C20, and the first regions C31 and C32 are judged to be included in the second region C30.

At Step #5, the control portion 10 performs a region linking process. Specifically, the control portion 10 links together a plurality of first regions that are included in the same second region.

In the example shown in FIGS. 5 and 6, the first regions C11 and C12 included in the second region C10 are linked together. The first regions C21 and C22 included in the second region C20 are linked together. The first regions C31 and C32 included in the second region C30 are linked together.

At Step #6, the control portion 10 performs a region discrimination process. By performing the region discrimination process, the control portion 10 recognizes, of the plurality of first regions linked together, which is a region of an item name and which is a region of an item value. In other words, by performing the region discrimination process, the control portion 10 distinguishes between a region of an item name and a region of an item value.

In the example shown in FIGS. 5 and 6, out of the second region C10, the first region C11 is judged to be a region of an item name and the first region C12 is judged to be a region of an item value. Out of the second region C20, the first region C21 is judged to be a region of an item name and the first region C22 is judged to be a region of an item value. Out of the second region C30, the first region C31 is judged to be a region of an item name and the first region C32 is judged to be a region of an item value.

By performing the region discrimination process, the control portion 10 recognizes the region of a target item. The region of a target item is a second region that includes both a first region corresponding to the item name of the target item and a first region corresponding to the item value of the target item. The region discrimination process will be described in detail later. Any other method can be used to recognize the regions of a target item.

At Step #7, the control portion 10 performs a masking process to mask at least part of a target item present in the image data of the personal identification card. By performing the masking process, the control portion 10 generates masked data in which at least part of a region of a target item present in the image data of the personal identification card is masked.

The control portion 10 masks the first region linked with the region of the item name of the target item (i.e., the region of the item value of the target item). Or the control portion 10 masks both the regions of the item name and the item value of the target item. Substantially the entire second region corresponding to the target item can be masked.

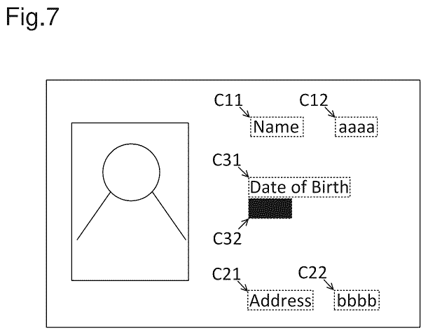

An example of masked data is shown in FIG. 7. The masked data shown in FIG. 7 is generated when the target item is date of birth. That is, at least the item value “cccc” corresponding to the item name “Date of Birth” is masked. Though not shown, both the item name “Date of Birth” and the item value “cccc” can be masked.

At Step #8, the control portion 10 makes an output portion perform an output process for the masked data. For example, in the setting of a masking job, an output method for masked data can be selected. The output method can be printing or transmission.

When printing is selected as the output method, the control portion 10 makes the printing portion 1 print (in other words, output) an image on the masked data on a sheet S. In this case, the printing portion 1 corresponds to the “output portion” and the output destination is the sheet S.

When transmission is selected as the output method, the control portion 10 makes the communication portion 102 transmit (in other words, output) the masked data to the PC 1000. Transmitting the masked data to the PC 1000 permits the masked data to be stored on the PC 1000. In this case, the communication portion 102 corresponds to the “output portion” and the output destination is the PC 1000.

In this embodiment, the first region detecting process, the second region detecting process, the including region detecting process, and the region linking process are performed. It is thus possible to accurately link together the regions of an item name and an item value corresponding to the same item in the image data of a personal identification card.

Owing to the regions of the item name and the item value corresponding to the same item in the image data of the personal identification card being linked together, it is easy to mask at least part of the target item. Specifically, it is sufficient to mask the region linked with the region of the item name of the target item. Doing so results in the item value of the target item being masked. With this configuration, it is easy, without transferring the image data of the personal identification card to a processing device on a cloud basis, to mask only the region corresponding to a user-specified item in the image data obtained through the reading of a document D (personal identification card).

If the region of an item value in the image data of a personal identification card can be masked, the personal information can be protected from leakage. Even if the region of the item name of a target item is masked, unless the region of the item value of the target item is masked, the personal information leaks. Thus, it is important to accurately perform a process of linking together the item name and the item value corresponding to the same item in the image data of the personal identification card.

Moreover, in this embodiment, the first region detecting process is performed using the first learning model and the second region detecting process is performed using the second learning model. Here, machine learning requires a huge amount of calculation and a huge amount of memory capacity. For this reason, processes related to machine learning are often performed on a processing device on a cloud basis. This, however, requires transfer of the image data of a personal identification card to the processing device on a cloud basis and is inconveniently susceptible to leakage of personal information.

To cope with that, in this embodiment, a first learning model that is trained is used and a second learning model that is trained is used. The first and second learning models are both previously stored in the storage portion 101. Thus, it is possible, without increasing the memory capacity within the multifunction peripheral 100, to perform the first and second region detecting processes within the multifunction peripheral 100. That is, there is no need to transfer the image data of a personal identification card to a processing device on a cloud basis.

### Region Discrimination Process

For each of a plurality of first regions (i.e., character regions containing character strings) present in the image data of a personal identification card, the control portion 10 performs a region discrimination process to check whether it is a region of an item name or a region of an item value. In the region discrimination process, dictionary data DD is used. The dictionary data DD is previously stored in the storage portion 101 (see FIG. 2).

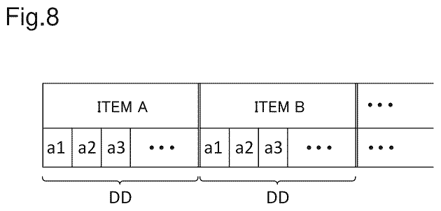

A conceptual diagram of the dictionary data DD is shown in FIG. 8. The dictionary data DD is data in which, for one kind of item, a plurality of different “similar items” are previously defined. One set of dictionary data DD is previously created for each of a plurality of kinds of item. The storage portion 101 previously stores a plurality of sets of dictionary data DD that correspond to a plurality of kinds of item respectively. The plurality of sets of dictionary data DD are previously created by the manufacturer of the multifunction peripheral 100 and are previously stored in the storage portion 101. In FIG. 8, items are identified as A, B,. Similar item names corresponding to item A are identified as a1, a2, a3, . . . . Similar item names corresponding to item B are identified as b1, b2, b3, . . .

Take, for example, an identification number as an item. On one personal identification card, the character string “ID” can be used as the item name; on another personal identification card, the character string “Number” can be used as the item name; on yet another personal identification card, the character string “Num” can be used as the item name. Although these character strings differ from each other, all correspond to the same item. Accordingly, the dictionary data DD corresponding to an identification number as the similar item has previously defined in it the character string “ID,” the character string “Number,” the character string “Num,” and the like.

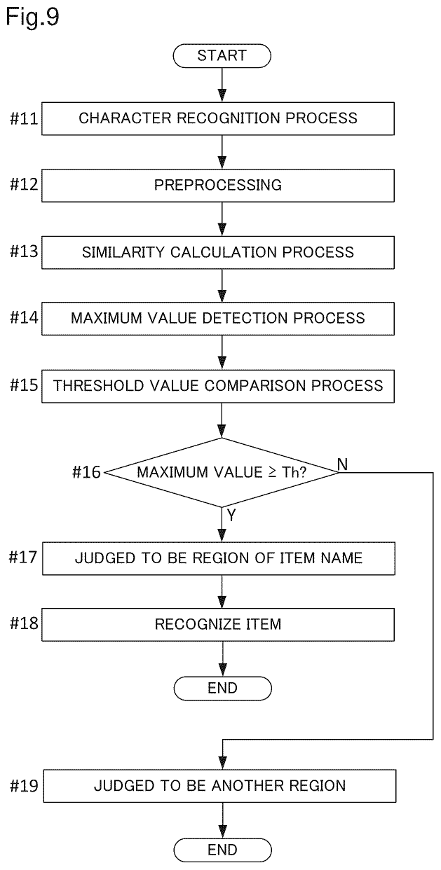

Now, with reference to the flow chart in FIG. 9, the procedure of the region discrimination process will be described. The flow in FIG. 9 starts when the control portion 10 completes the region linking process.

At Step #11, the control portion 10 performs a character recognition process on the image data of the personal identification card obtained through the reading of the personal identification card by the image reading portion 2 (i.e., the process at Step #1 in FIG. 4). The control portion 10 performs an OCR process on the image data of the personal identification card. Thus, from each of a plurality of first regions present in the image data of the personal identification card, the control portion 10 extracts a character string. The control portion 10 recognizes the character string in each of the plurality of first regions. Here, a first region contains a character string representing an item name or a character string representing an item value.

At Step #12, the control portion 10 performs preprocessing on the plurality of character strings extracted in the character recognition process. There is no particular limitation on what to perform as the preprocessing. For example, the control portion 10 performs as the preprocessing a process of reorganizing character strings into upper-or lower-case characters. After this process, upper-and lower-case characters in character strings are no longer distinguished. For another example, the control portion 10 performs as the preprocessing a process of removing spaces and predetermined symbols.

After the process at Step #12, the control portion 10 performs an item name region discrimination process. In performing the item name region discrimination process, the control portion 10 sets as the process target one of the plurality of first regions detected in the first region detecting process.

As one process in the item name region discrimination process, the control portion 10 performs a similarity calculation process (the process at Step #13). At Step #13, the control portion 10 calculates the degree of similarity of the character string in the first region of the process target to all of the similar item names defined in the plurality of sets of dictionary data DD. In the following description, the degree of similarity between character strings is referred to as the degree of character string similarity for distinction from the degree of image similarity.

When performing the similarity calculation process, the control portion 10 selects one of the plurality of sets of dictionary data DD (here, the selected set of dictionary data DD is referred to as the target dictionary data DD). The control portion 10 also selects one of the plurality of similar item names defined in the target dictionary data DD (here, the selected similar item name is referred to as the target similar item name).

The control portion 10 then calculates the degree of similarity of the character string in the first region of the process target to the character string of the target similar item name. For example, Expression (1) can be used to find the degree of similarity Sd of the character string in the first region of the process target to the character string of the target similar item name.

$$Sd = \frac{2 M}{len ( {S}_{1} ) + len ( {S}_{2} )} ∈ [ 0 , 1 ] \qquad ( 1 )$$

In Expression (1), S1 represents one character string and S2 represents the other character string. For example, the character string of the similar item name defined in the dictionary data DD is S1 and the character string in the first region extracted from the image data of the personal identification card is S2. The term len (S1) represents the number of characters in the character string SI and the term len (S1) represents the number of characters in the character string S2. M represents the number of characters that match between the character strings S1 and S2.

Suppose, for example, the character string SI is “Number” and the character string S2 is “Nombern.” It can occur that, although the personal identification card shows “Number,” the character recognition process recognizes it as “Nombern.”

In this example, len (S1)=6and len (S2)=7. Between the character strings S1 and S2, counted from their head, the first character “N,” the third character “m,” the fourth character “b.”, the fifth character “,” and the sixth character “r” match; hence M=5.

In this example, the degree of similarity has a value of 0.76923. For the sake of discussion, if the character strings S1 and S2 contain completely different characters (i.e., if M=0), the degree of similarity has a value of 0; if the character strings S1 and S2 contain completely identical characters (i.e., if M=len (S1)=len (S2)), the degree of similarity has a value of 1. That is, in the calculation of the degree of similarity between the character string in the first region of the process target and the character string of the target similar item name, the higher the degree of similarity it has a larger value, and the lower the degree of similarity it has a smaller value.

After calculating the degree of character string similarity of the character string in the first region of the process target to the character string of the target similar item name, the control portion 10 newly selects an unselected similar item name out of the plurality of similar item names defined in the target dictionary data DD. The control portion 10 switches the target similar item name and calculates the degree of character string similarity of the character string in the first region of the process target to the character string of the new target similar item name. For all of the plurality of similar item names defined in the target dictionary data DD, the control portion 10 calculates the degree of character string similarity to the character string in the first region of the process target. The control portion 10 then stores, of the plurality of similar item names defined in the target dictionary data DD, the similar item name with the highest degree of character string similarity to the character string in the first region of the process target in a form associated with the value of the degree of character string similarity.

Moreover, for all the similar item names defined in the plurality of sets of dictionary data DD, the control portion 10 finds the degree of similarity to the character string in the first region of the process target. That is, the control portion 10 newly selects an unselected set of dictionary data DD out of the plurality of sets of dictionary data DD. The control portion 10 switches the dictionary data DD and, for all of the plurality of similar item names defined in the new target dictionary data DD, the control portion 10 finds the degree of similarity to the character string in the first region of the process target. The control portion 10 then stores, of the plurality of similar item names defined in the target dictionary data DD, the similar item name with the highest degree of character string similarity to the character string in the first region of the process target in a form associated with the value of the degree of character string similarity. In this way, a plurality of similar item names corresponding to a plurality of kinds of item are stored one by one in a form associated with the value of the degree of character string similarity. In other words, a plurality of similarity values (which are values of the degree of character string similarity) respectively corresponding to a plurality of kinds of item are stored.

The control portion 10 performs, as one process in the item name region discrimination process, a maximum value detection process (the process at Step #14). At Step #14, the control portion 10 compares with each other the plurality of similarity values (which are values of the degree of character string similarity) stored in the similarity calculation process. In other words, the control portion 10 compares with each other a plurality of similarity values corresponding respectively to a plurality of kinds of item.

The control portion 10 then detects the maximum value of the degree of character string similarity (i.e., the highest similarity value). Specifically, the control portion 10 finds the degree of character string similarity of the character string in the first region of the process target to each character string in all the similar item names to detect the maximum value among the plurality of similarity values thus found.

The control portion 10 performs, as one process in the item name region discrimination process, a threshold value comparison process (the process at Step #5). At Step #15, the control portion 10 compares a prescribed threshold value for the item name region discrimination process with the maximum value of the degree of character string similarity.

For example, to set a threshold value for the item name region discrimination process, a personal identification card is actually read on the multifunction peripheral 100 and, for a character string present in the region of an item name in the image data obtained through the reading, the result of the similarity calculation process is acquired (here, the value acquired as that result will be referred to as the similarity value of an item name region). Moreover, for a character string present in a region different from a region of an item name in that image data, the result of the similarity calculation process is acquired (here, the value acquired as that result will be referred to as the similarity value of another region). Note that a plurality of similarity values of item name regions are acquired and a plurality of similarity values of other regions are acquired.

Also calculated are a first average value, which is the average value of the similarity values of a plurality of item name regions, and a second average value, which is the average value of a plurality of other regions. Then the average value of the first and second average values is taken as the threshold value for item name region discrimination process.

At Step #16, the control portion 10 checks whether the maximum value of the degree of character string similarity is equal to or more than the threshold value for the item name region discrimination process. In FIG. 9, the threshold value for the item name region discrimination process is represented by Th. If the control portion 10 judges that the maximum value of the degree of character string similarity is equal to or more than the threshold value for the item name region discrimination process, an advance is made to Step #17.

At Step #17, the control portion 10 judges the first region of the process target to be a region of an item name. At Step #18, based on the character string as the item name present in the first region (i.e., the first region judged to be a region of an item name) of the process target, the control portion 10 recognizes the item corresponding to the first region of the process target. Here, the character string in the first region of the process target is defined as a similar item name in some set of dictionary data DD. Accordingly, the control portion 10 recognizes the item that corresponds to the dictionary data DD in which the character string in the first region of the process target is defined, and recognizes the thus recognized item as the item that corresponds to the first region of the process target.

If at Step #16 the control portion 10 judges that the maximum value of the degree of character string similarity is less than the threshold value for the item name region discrimination process, an advance is made to Step #19. At Step #19, the control portion 10 judges that the first region of the process target is another region (i.e., a region other than a region of an item name).

The processes at Steps #13 to #19 are each performed as one process in the item name region discrimination process. After completion of the item name region discrimination process for the first region of a given process target, the control portion 10 checks whether there remains any first region for which the item name region discrimination process has not been performed (here referred to as an unprocessed first region). If any unprocessed first region remains, the control portion 10 sets the unprocessed first region as a new process target. That is, the control portion 10 switches process targets. Then the control portion 10 performs the item name region discrimination process (the processes at Steps #13 to #19) on the first region of the new process target.

In the embodiment, for each of a plurality of kinds of item, dictionary data DD in which for that one kind of item a plurality of different similar item names are previously defined is previously stored in the storage portion 101. Using the dictionary data DD, the item name region discrimination process is performed. It is thus possible, in a case where an item to which a plurality of item names correspond is the masking target, to prevent inconsistency in which, for a personal identification card that contains a particular item name among the plurality of item names, the masking target item is masked correctly while, for a personal identification card that contains another item name among them, the masking target item is not masked (in other words, the masking target item is not detected).

For example, suppose an identification number as an item is the masking target. In that case, in the embodiment, for both a personal identification card that bears “ID” as an item name and a personal identification card that bears “Num” as an item name, the identification number is masked correctly. On the other hand, with the conventional configuration, inconsistency can occur in which, for a personal identification card that bears “ID” as an item name, the identification number is masked correctly while, for a personal identification card that bears “Num” as an item name, the identification number is not masked.

Suppressing such inconsistency requires large dictionaries. In addition, a method relying on a machine learning model requires a large-size model. Since available memory capacity is limited, the processing has to be done on a cloud basis.

In the embodiment, the use of dictionary data DD eliminates the need for processing on a cloud basis. That is, there is no need to transfer the image data of a personal identification card (i.e., personal information) to a processing device on a cloud basis. It is thus possible to prevent leakage of personal information. In other words, according to the embodiment, it is possible to easily mask only a region corresponding to an item specified by the user out of the image data obtained by reading a document D (personal identification card) without transferring the image data of the personal identification card to a processing device on a cloud basis.

Moreover, in the embodiment, the degree of character string similarity of the character string in the first region of the process target to each character strings in all the similar item names is calculated and if the maximum value of the calculated degree of character string similarity is equal to or greater than a threshold value the first region of the process target is judged to be a region of an item name. Thus, even in the event of incorrect recognition in the character recognition process, it is possible to accurately detect a region of a item name.

For the purpose of detecting a region corresponding to a specified item out of image data obtained by reading, a method using a language model such as BERT (bidirectional encoder representations from transformers) is often employed. Inconveniently, this model requires a large-size model and a huge amount of calculation. Thus, the image data of a personal identification card is transferred to a cloud system so that it is processed on a cloud basis.

Transferring the image data of a personal identification card to a cloud system inconveniently leads to leakage of personal information. It is thus not preferable to transfer the image data of a personal identification card to a cloud system.

### Error Handling Process

First, a first error handling process will be described.

Typically a personal identification card bears a plurality of different items related to personal information. For example, a single personal identification card seldom bears a plurality of items labeled “Name.” However, if the image data of a personal identification card is subjected to a low-accuracy character recognition process, a plurality of item names (their character strings) all corresponding to the same item may be extracted from the image data of the personal identification card. If the personal identification card is partly soiled or discolored, or if the personal identification card is read at low resolution, the character recognition process has low accuracy.

To prevent such inconvenience, the control portion 10 performs the first error handling process. Specifically, if the character strings of all of the plurality of first regions judged to be regions of item names correspond to the same item, namely a first item, the control portion 10 judges, of those first regions, the first region containing the character string with the highest maximum value to be the region corresponding to the first item and judges the other first regions not to be regions corresponding to the first item. In other words, the control portion 10 corrects the result of the item name region discrimination process.

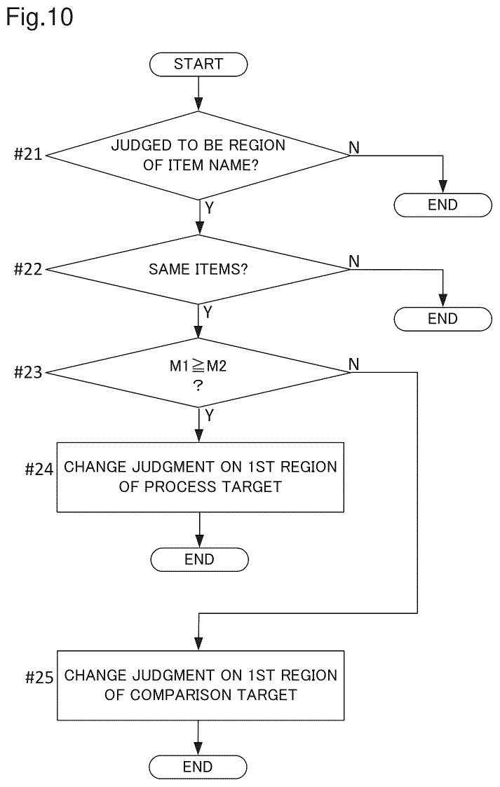

Now, with reference to the flow chart in FIG. 10, the procedure of the first error handling process will be described. The flow in FIG. 10 starts when the control portion 10 completes the item name region discrimination process (the procedure along the flow in FIG. 9). After completing the item name region discrimination process the control portion 10 proceeds to perform the first error handling process on the first region of the process target.

At Step #21, the control portion 10 checks whether the first region of the process target has been judged to be a region of an item name. If the control portion 10 has judged the first region of the process target to be a region of an item name, an advance is made the Step #22. If the control portion 10 has judged the first region of the process target not to be a region of an item name, the flow ends.

At Step #22, the control portion 10 checks whether the item corresponding to the first region of the process target is the same as the item corresponding to the other first regions. In other words, the control portion 10 checks whether the character strings in all of the plurality of first regions judged to be regions of item names correspond to the same item (first item).

If in Step #22 the control portion 10 judges that the item corresponding to the first region of the process target is the same as the item corresponding to the other first regions, an advance is made to Step #23. In other words, if the control portion 10 judges that the character strings in all of the plurality of first regions judged to be regions of item names correspond to the same item (first item), an advance is made to Step #23. If the control portion 10 judges that the item corresponding to the first region of the process target is different from the item corresponding to the other first regions, the flow ends. In the following description, the other first regions to which the same item that corresponds to the first region of the process target corresponds are referred to as the first regions of the comparison targets.

At Step #23, for each of the first region of the process target and the first regions of the comparison targets, the control portion 10 recognizes the maximum value calculated in the maximum value detection process (i.e., the process at Step #14 in FIG. 9). The control portion 10 then compares the maximum values of the first region of the process target and the first regions of the comparison targets with each other. Thus the control portion 10 compares the maximum values of the first region of the process target and the first regions of the comparison targets with each other. For example, the control portion 10 checks whether the maximum value M1 of the first region of the process target is equal to or greater than the maximum value M2 of the first regions of the comparison targets.

If at Step #23 the control portion 10 judges that the maximum value M1 of the first region of the process target is equal to or greater than the maximum value M2 of the first regions of the comparison targets, an advance is made to Step #24. If the control portion 10 judges that the maximum value M1 of the first region of the process target is less than the maximum value M2 of the first regions of the comparison targets, an advance is made to Step #25.

At Step #24, the control portion 10 does not change the judgment that the first region of the process target is a region corresponding to the first item and changes the judgement on the first regions of the comparison targets. Specifically, the control portion 10 recognizes as a second item an item corresponding to the similar item name with the second highest degree of character string similarity to the character string in the first regions of the comparison targets and judges that the first regions of the comparison targets are regions corresponding to the second item.

At Step #25, the control portion 10 does not change the judgment that the first regions of the comparison targets are regions corresponding to the first item and changes the judgement on the first region of the process target. Specifically, the control portion 10 recognizes as a second item an item corresponding to the similar item name with the second highest degree of character string similarity to the character string in the first region of the process target and judges that the first region of the process target is a region corresponding to the second item.

In other words, at Steps #23 to #25, the following processes are performed.

If the character strings in all of the plurality of first regions judged to be regions of item names correspond to the same item, namely the first item, the control portion 10 judges that, of those first regions, the first region containing the character string with the highest maximum value is a region corresponding to the first item. The control portion 10 recognizes as a second item an item corresponding to the similar item name with the second highest degree of character string similarity to the character strings in, out of the plurality of first regions, the first regions judged not to be regions corresponding to the first item and judges that the first regions judged not to be regions corresponding to the first item correspond to the second item.

Next, a second error handling process and a third error handling process will be described.

A personal identification card has a plurality of item boxes. Each item box is labeled with one item name; one item box is seldom labeled with a plurality of item names. That is, it usually does not occur that, of a plurality of first regions included in the same second region, two or more of them are judged to be regions of item names. Also usually, of a plurality of first regions included in the same second region, one is judged to be a region of an item name. However, if the accuracy of the character recognition process on the image data of the personal identification card is low, it can occur that, of a plurality of first regions included in the same second region, two or more are judged to be regions of item names or none is judged to be a region of an item name.

To cope with that, the control portion 10 performs the second and third error handling processes. Here, a plurality of first regions included in the same second region are linked together. Accordingly, the control portion 10 performs the second or third error handling process on a plurality of first regions that are linked together.

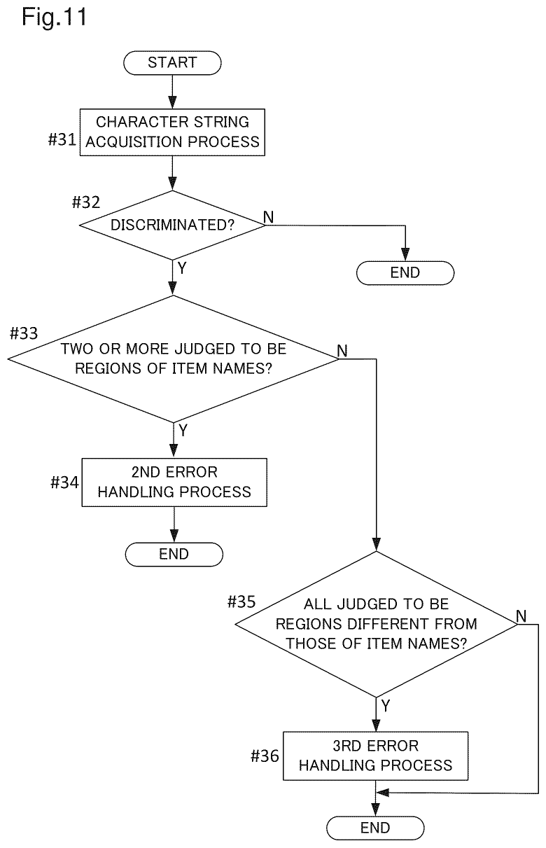

Now, with reference to the flow charts in FIGS. 11 to 13, the procedures of the second and third error handling processes will be described.

First, the control portion 10 performs the procedure along the flow in FIG. 11. The flow in FIG. 11 starts when the control portion 10 completes the region discrimination process (i.e., the procedure along the flow in FIG. 9). After completing the region discrimination process, the control portion 10 proceeds to perform the procedure along the flow in FIG. 11.

At Step #31, the control portion 10 performs a character string acquisition process to acquire the character string in the first region linked with the first region of the process target. Then, at Step #32, the control portion 10 checks whether it has performed the region discrimination process on the first region that contains the character string acquired in the character string acquisition process (i.e., whether it has discriminated it). If it judges to have discriminated it, an advance is made to Step #33 and, if it judges not to have discriminated it, the flow ends.

At Step #33, the control portion 10 checks whether it has judged both the first region of the process target and the first region linked with the first region of the process target to be regions of item names. In other words, the control portion 10 checks whether it has judged two or more of the plurality of first regions linked together to be regions of item names.

If at Step #33 the control portion 10 judges that it has judged two or more of the plurality of first regions linked together to be regions of item names, an advance is made to Step #34. At Step #34, the control portion 10 performs the second error handling process.

If at Step #33 the control portion 10 judges that it has not judged two or more of the plurality of first regions linked together to be regions of item names, an advance is made to Step #35. At Step #35, the control portion 10 checks whether it has judged both the first region of the process target and the first region linked with the first region of the process target to be regions different from regions of item names. In other words, the control portion 10 checks whether it has judged all of the plurality of first regions linked together to be regions different from regions of item names.

If at Step #35 the control portion 10 judges that it has judged all of the plurality of first regions linked together to be regions different from regions of item names, an advance is made to Step #36. At Step #36, the control portion 10 performs the third error handling process.

If at Step #35 the control portion 10 judges that it has not judged all of the plurality of first regions linked together to be regions different from regions of item names, the flow ends. That is, if only one of the plurality of first regions linked together has been judged to be a region of an item name, neither the second nor the third error handling process is performed.

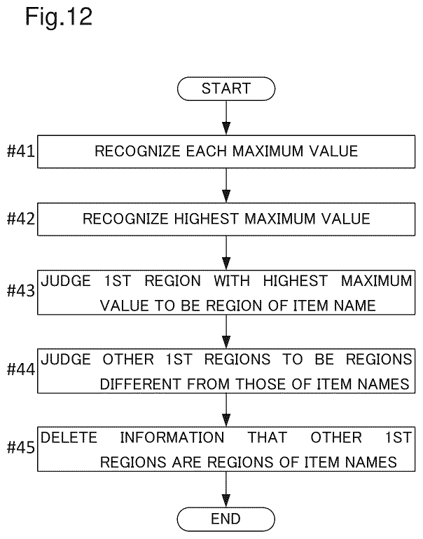

As the second error handling process, the procedure along the flow in FIG. 12 is performed. That is, if the control portion 10 judges two or more of the plurality of first regions linked together (i.e., the plurality of first regions included in the same second region) to be regions of item names, the procedure along the flow in FIG. 12 is performed.

At Step #41, for each of the plurality of first regions linked together the control portion 10 recognizes the maximum value calculated in the maximum value detection process (i.e., the process at Step #14 in FIG. 9). Then, at Step #42, the control portion 10 recognizes the highest value among the maximum values.

Then, at Step #43, the control portion 10 judges, of the plurality of first regions linked together, the first region that contains the character string with the highest value among the maximum values (here referred to as the first region with the highest maximum value) to be a region of an item name. Then, at Step #44, the control portion 10 judges, of the plurality of first regions linked together, the first regions other than the first region with the highest maximum value to be regions different from regions of item names.

Here, if a first region present in the image data of a personal identification card is judged to be a region of an item name, the control portion 10 memorizes the information that that first region is a region corresponding to an item name. With this configuration, when the second error handling process is performed, for a first region that is re-judged to be a region different from a region of item name, the information that it is a region corresponding to an item name should be deleted. Accordingly, at Step #45, the control portion 10 deletes the information that the first regions other than the first region with the highest maximum value are regions corresponding to item names.

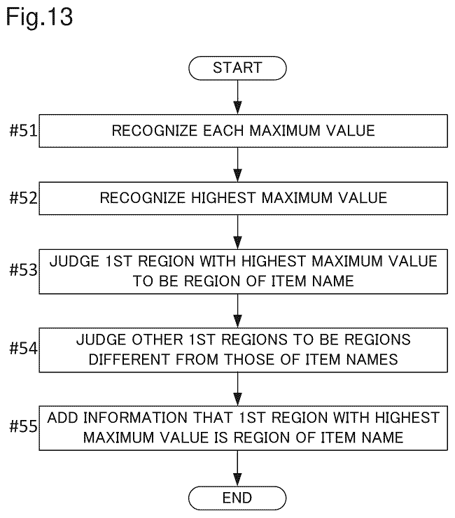

As the third error handling process, the procedure along the flow in FIG. 13 is performed. Specifically, if the control portion 10 judges all of the plurality of first regions linked together (i.e., the plurality of first regions included in the same second region) to be regions different from regions of item names, the procedure along the flow in FIG. 13 is performed.

At Step #51, for each of the plurality of first regions linked together the control portion 10 performs the maximum value detection process (i.e., the process at Step #14 in FIG. 9). Then, at Step #52, the control portion 10 recognizes the highest value among the maximum values.

Then, at Step #53, the control portion 10 judges, of the plurality of first regions linked together, the first region containing the character string with the highest value among the maximum values (here referred to as the first region with the highest maximum value) to be a region of an item name. Then at Step #54 the control portion 10 judges, of the plurality of first regions linked together, the first regions other than the first region with the highest maximum value to be regions different from regions of item names.

Here, if a first region present in the image data of a personal identification card is judged to be a region of an item name, the control portion 10 memorizes the information that that first region is a region corresponding to an item name. With this configuration, when the third error handling process is performed, for a first region that is re-judged to be a region of an item name, the information that it is a region corresponding to an item name should be added. Accordingly, at Step #55, the control portion 10 adds the information that the first region with the highest maximum value is a region corresponding to an item name.

In this embodiment, performing the first to third error handling processes helps prevent the inconvenience in which a plurality of regions of item names are detected as corresponding to the same item. It is also possible to prevent the inconvenience in which no region of an item name is detected.

### Settings of a Masking Job

For a masking job, the user can do its setting. The setting of a masking job is done via the operation/display portion 3. For example, the user can specify an item corresponding to an item value to be masked (i.e., a target item).

Specifically, the operation/display portion 3 accepts an item specifying operation for specifying a particular item. The control portion 10 recognizes the item specified by the item specifying operation as the target item. The control portion 10 then generates masked data by masking at least the region of the item value out of the region of the target item present in the image data of the personal identification card.

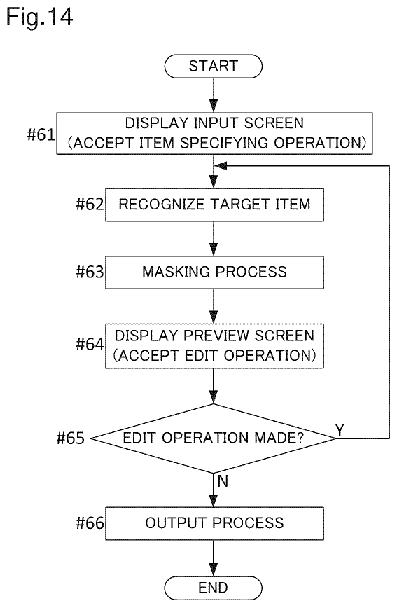

Now, with reference to the flow chart in FIG. 14, the procedure that the control portion 10 performs when receiving the setting of a masking job will be described. For example, in a masking job, after the image reading portion 2 reads a personal identification card, before the masking job is started, the operation/display portion 3 accepts the item specifying operation. That is, after Step #1 in FIG. 4, before Step #7, the flow in FIG. 14 starts.

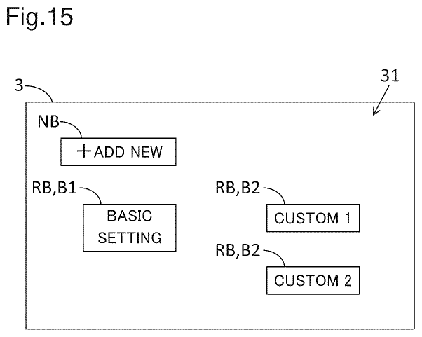

At Step #61, the operation/display portion 3 displays an input screen 31 as shown in FIG. 15. The input screen 31 shows input buttons RB. The input buttons RB include a basic setting button B1 and a custom button B2. The operation/display portion 3 accepts as the item specifying operation an operation on one of the input buttons RB. According to on which input button RB the item specifying operation is performed, the control portion 10 recognizes the item specified by the user (i.e., the target item).

Specifically, the storage portion 101 stores a masking list in which at least one item is registered. The input buttons RB are associated with masking lists. If there are a plurality of masking lists, a plurality of (specifically, as many as there are masking lists) input buttons RB are shown on the input screen 31. The plurality of input buttons RB are associated with different masking lists respectively.

The masking list corresponding to the basic setting button B1 has registered in it those items which the manufacturer has previously selected. The masking list corresponding to the custom button B2 has registered in it those items which the user has freely selected. Making a new masking list leads to a custom button B2 (i.e., an input button RB) corresponding to the new masking list to be shown on the input screen 31.

To accept a request to make a new masking list from the user, an add new button NB is shown on the input screen 31. The operation/display portion 3 accepts an operation on the add new button NB as a request to make a new masking list.

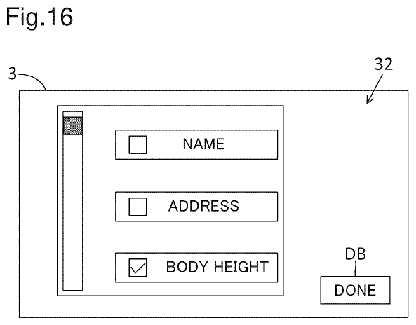

On receiving a request to make a new masking list, the operation/display portion 3 displays a registration screen 32 as shown in FIG. 16 to accept from the user a registration operation for selecting an item as a registration target. The registration screen 32 shows a plurality of items (their item names) as possible choices.

The operation/display portion 3 accepts as a registration operation an operation on the display box of any of the items being displayed. If the user wants to register the item “body height,” the user can operate the display box of the item “body height” to select the item “body height” as a registration target. The display box of the item selected by the registration operation is put a check mark. When a done button DB on the registration screen 32 is operated, the selection of an item by the registration operation can be completed.

When the done button DB is operated, the control portion 10 judges to have accepted a registration operation. After accepting the registration operation, the control portion 10 makes a new masking list in which the item selected by the registration operation is registered and stores it in the storage portion 101.

When a new masking list is made, if after that the operation/display portion 3 accepts an item specifying operation, the control portion 10 makes the operation/display portion 3 display an input screen 31 that shows, in addition to the input buttons RB corresponding to the existing masking list, an input button RB corresponding to the new masking list.

When any of the input buttons RB is operated, the control portion 10 judges that the operation/display portion 3 has accepted an item specifying operation. At that time the control portion 10 judges that the masking list corresponding to the input button RB on which the item specifying operation has been made is specified. That is, an item specifying operation is an operation for specifying a particular masking list.

Back in FIG. 14, at Step #62, the control portion 10 recognizes the input button RB on which the item specifying operation has been made, that is, it recognizes the masking list specified by the item specifying operation. The control portion 10 then recognizes as the target item the item registered in the masking list specified by the item specifying operation.

At Step #63 the control portion 10 performs the masking job. The process at Step #63 is the same as the process at Step #7 in FIG. 4. It is after performing the processes at Steps #2 to #6 in FIG. 4 that the control portion 10 performs the masking process.

At Step #64 the control portion 10 makes the operation/display portion 3 display a preview image (not shown) that shows the masked data and in addition makes the operation/display portion 3 accept an edit operation for editing the masked data. The edit operation is an operation for changing the item to be masked. That is, the edit operation includes an operation of adding a new item as a masking target and an operation of excluding a masked item from the masking target.

At Step #65 the control portion 10 checks whether an edit operation has been made. If an edit operation has been made, an advance is made to Step #61. After that, at Step #63, the control portion 10 generates new masked data that reflects the edits made by the edit operation.

If at Step #65 no edit operation has been made, an advance is made to Step #66. At Step #66, the control portion 10 makes the output portion perform an output process for the masked data. The process at Step #66 is the same as the process at Step #8 in FIG. 4.

In the embodiment, after a personal information is scanned, an item specifying operation for specifying an item to be masked (i.e., a target item) is accepted. Making the item specifying operation results in the region of at least the item value out of the region of the target item present in the image data of the personal identification card being masked. That is, out of the image data obtained by reading a document D (personal identification card), only the region corresponding to the item specified by the user can be masked easily.

For example, with a conventional configuration, it is necessary to previously scan a personal identification card and register the region to be masked (its position in image data). In other words, the personal identification card has to be registered previously. With the conventional configuration, if the personal identification card is previously registered, a desired region in the image data of the personal identification card can be masked.

It is however troublesome for the user to previously register a personal identification card. If there are many kinds of personal identification card to be registered, they have to be previously registered kind by kind, which is quite troublesome. Moreover, the masking target cannot be changed flexibly. Changing the masking target requires registering a personal identification card all over again.

By contrast, according to the embodiment, performing the item specifying operation permits, when a particular personal identification card is read, out of its image data the region of the item specified by the item specifying operation is masked and, also when another particular personal identification card is read, out of its image data the region of the item specified by the item specifying operation is masked. Also, for example, in a case where item A is a masking target, if item B has to be added as a masking target (i.e., if the masking target has to be changed), that is achieved simply be specifying items A and B in the item specifying operation. These features eliminate the need for operation corresponding to previous registration of a personal identification card and this adds to user convenience.

Moreover, in the embodiment, the item specifying operation is an operation for specifying a masking list. This, if the masking of a plurality of items is desired, there is no need to specify one by one the items to be masked. This further adds to user convenience.

Moreover, according to the embodiment, it is possible to make a new masking list. The user can thus freely make a masking list, which is convenient.

Also, according to the embodiment, masked data can be edited, and this adds to user convenience. Here, when masked data is edited, a preview image showing the masked data is displayed. The user can thus edit masked data while previewing it and this allows efficient editing of masked data.

### Masking a Hand-Written Signature

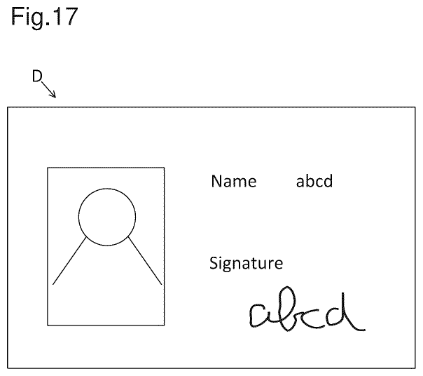

Some personal identification cards bear a hand-written signature. A hand-written signature is one kind of personal information. A hand-written signature is a character string composed of handwritten characters. One example of such a document D (i.e., a personal identification card that contains a hand-written signature) is shown in FIG. 17. In FIG. 17, for convenience' sake, the character string “abcd” represents the hand-written signature.

For example, the first learning model for the first region detection process is trained to detect a region containing characters as a first region, and the characters in this region are printed characters. Likewise, the second learning model for the second region detection process too is trained to detect a region containing characters as a second region, and the characters in this region are printed characters.

Accordingly, the first and second region detection processes detect a printed character region in which all the characters are printed characters. That is, the first region detected in the first region detection process and the second region detected in the second region detection process are printed character regions.

Here, there can be cases where a hand-written signature as personal information has to be selectively masked. Inconveniently, the first and second region detection processes may be unable to detect a region of a hand-written signature. For example, with a hand-written signature composed of hardly readable hand-written characters, the first and second region detection processes do not detect the region of the hand-written signature. Thus, only performing those two processes, namely the first and second region detection processes, as processes for detecting from image data a region that can be a target of masking can inconveniently lead to an inability to mask a hand-written signature.

To cope with that, as a process for detecting from image data a region that can be a masking target, the control portion 10 further performs a hand-written region detection process. The hand-written region detection process detects, from the image data obtained by reading a personal identification card, a hand-written region in which all the characters present are hand-written characters.

In a case where the hand-written region detection process is additionally performed, in the setting of a masking job, a hand-written signature (i.e., personal information in hand writing) can be specified as personal information to be masked. For example, on the registration screen 32 (see FIG. 16), the item “hand-written signature” is added as a choice. When the item “hand-written signature” is selected, on the input screen 31 (see FIG. 15) an input button RB corresponding to a masking list in which the item “hand-written signature” is registered is displayed. When that input button RB is operated the control portion 10 recognizes the hand-written signature as personal information to be masked. With this configuration, an operation on the input button RB corresponding to the masking list corresponds to an operation for specifying the hand-written signature as personal information to be masked. That is, the operation/display portion 3 accepts an operation for specifying information to be masked.

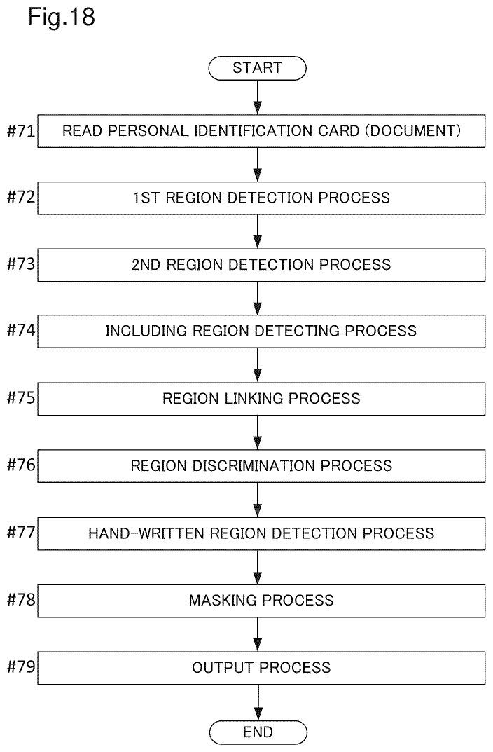

Now, with reference to the flow chart in FIG. 18, a description will be given of the procedure of the masking job in a case where the hand-written region detection process is additionally performed.

When a starting operation for the masking job is made on the operation/display portion 3, the flow in FIG. 18 starts. The control portion 10 performs the processes at Steps #71 to #76 sequentially. The processes at Steps #71 to #76 are the same as the processes at Steps #1 to #6. Accordingly, no detailed description will be repeated for the processes at Steps #71 to #76, for which the description of the processes at Steps #1 to #6 is to be referred to.

Next, at Step #77, using a third learning model obtained through machine learning, the control portion 10 performs the hand-written region detection process. The third learning model for the hand-written region detection process is a learning model trained to detect a hand-written region from the image data obtained through the reading of a personal identification card by the image reading portion 2. The third learning model is a trained model and is previously stored in the storage portion 101.

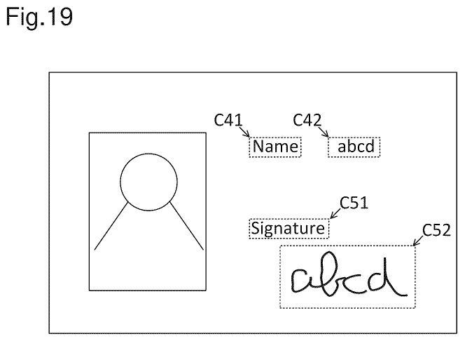

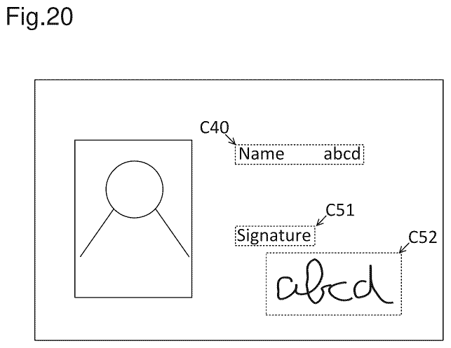

For example, in a case where the personal identification card shown in FIG. 17 is read, as shown in FIG. 19 a character region C41 of the item name “Name,” a character region C42 of the item value “abcd (in printed characters),” and a character region C51 of the item name “Signature” are each detected as a first region. Here, the character string “Name” corresponds to an item name and the character string “abcd (in printed characters)” corresponds to the item value of the item corresponding to the item name “Name.” Accordingly, as shown in FIG. 20, a region C40 that includes the character regions C41 and C42 is detected as a second region.

Here, in the personal identification card shown in FIG. 17, the character strings C41, C42, and C51 are each a printed character region. On the other hand, the character string “abcd” below the character region C51 is a hand-written signature. That is, all the characters present in the character region C52 are hand-written characters. In this case, in the first region detection process, the character regions C41, C42, and C51 are each detected as a first region while the character region C52 is not detected as a first region. Nor in the second region detection process is the character region C52 detected as a second region.

On the other hand, in the hand-written region detection process, the character region C52 is detected as a hand-written region. All the characters present in the other character regions are printed characters. Thus, none of the other character regions is detected as a hand-written region.

After the process at Step #77 (hand-written region detection process), at Step #78 the control portion 10 performs the masking process. Then, at Step #79, the control portion 10 performs the output process. The processes at Steps #78 and #79 are the same as the processes at Steps #7 and #8. Accordingly, no detailed description will be repeated for the processes at Steps #78 and #79, for which the description of the processes at Steps #7 and #8 is to be referred to.

For example, if the operation/display portion 3 accepts an operation for specifying a hand-written signature as personal information to be masked, the control portion 10 masks a hand-written region in the image data of the personal identification card. Here, for the hand-written region the control portion 10 does not perform a character recognition process. Accordingly if the operation/display portion 3 accepts an operation for specifying a hand-written signature as personal information to be masked, regardless of what is represented by the characters present in the hand-written region the control portion 10 masks the entire hand-written region.

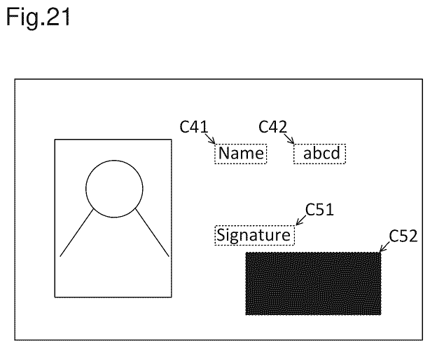

Thus, in a case where the personal identification card shown in FIG. 17 is the reading target and in addition a hand-written signature is the personal information to be masked, masked data as shown in FIG. 21 is generated. That is, the character region C52 as a hand-written region is masked.

In the embodiment, in addition to the first and second region detection processes, the hand-written region detection process is performed and this allows accurate detection of a hand-written region present in the image data of a personal identification card. Here, if a hand-written region is present in a personal identification card, the hand-written region detection process is performed on the image data of the personal identification card so that a region corresponding to the hand-written region in the image data of the personal identification card is detected as a hand-written region. Thus, when a hand-written signature is specified as personal information to be masked, by masking the hand-written region in the image data of the personal identification card it is possible to reliably mask the personal information specified by the user.

Moreover, in the embodiment, the third learning model that is trained is used. The third learning model is previously stored in the storage portion 101. Thus, with no increase in the memory capacity within the multifunction peripheral 100 the hand-written region detection process can be performed within the multifunction peripheral 100. That is, there is no need to transfer the image data of the personal information to a processing device on a cloud basis. It is thus possible to prevent leakage of personal information.

The embodiment disclosed herein should be understood to be in every aspect illustrative and not restrictive. The scope of the present disclosure is defined not by the description of the embodiment given above but by the appended claims and encompasses any modifications within a scope equivalent in significance to the scope of those claims.

What is claimed is:

1. An image processing apparatuses comprising:
an image reading portion that reads a document that contains a plurality of sets of item names and item values with respect to items related to personal information; and
a control portion that recognizes a target item which is, among the items, an item to be masked and that, by performing a masking process on image data obtained through reading of the document by the image reading portion, generates masked data in which at least part of a region of the target item present in the image data is masked,
wherein
the control portion performs
a first region detection process to detect, from the image data, a first region expected to individually include either a region of an item name or a region of an item value,
a second region detection process to detect a second region expected to include both the region of the item name and the region of the item value corresponding to a same item,
an including region detection process, as a process performed for each of a plurality of the first regions, to detect a second region having an image portion with a degree of image similarity equal to or greater than a threshold value with respect to the first region of a process target, thereby to detect the second region that includes the first region, and
a region linking process to link together a plurality of the first regions included in a same second region,
in the first and second region detection processes, a printed character region in which characters are printed characters is detected, and
the control portion further performs a hand-written region detection process to detect a hand-written region in which characters are hand-written characters.

2. The image processing apparatuses according to claim 1, further comprising a storage portion, wherein
the storage portion previously stores
a first learning model trained, through machine leaning, to detect the first region from the image data,
a second learning model trained, through machine leaning, to detect the second region from the image data, and
a third learning model trained, through machine leaning, to detect the hand-written region from the image data, and
the control portion
performs as the first region detection process a process of detecting the first region from the image data using the first learning model,
performs as the second region detection process a process of detecting the second region from the image data using the second learning model, and
performs as the hand-written region detection process a process of detecting the hand-written region from the image data using the third learning model.

3. The image processing apparatuses according to claim 1, further comprising an operation/display portion that displays information and that accepts operations, wherein
the operation/display portion accepts an operation to specify information to be masked,
the control portion does not perform a character recognition process for the hand-written region, and
if the operation/display portion accepts an operation to specify a hand-written signature as information to be masked, the control portion masks the hand-written region.

4. The image processing apparatuses according to claim 1, further comprising an output portion that performs an output process for the masked data, wherein
the output portion is at least one of
a printing portion that, as the output process, prints an image based on the masked data on a sheet and
a communication portion that, as the output process, transmits the masked data to an external device.
